(19) United States
(12) Patent Application Publication
(10) Pub. No.: US 2011/0067941 A1
(43) Pub. Date: Mar. 24, 2011

(54) VEHICLE WITH REVOLVING DRIVER STATION

(76) Inventor: Rodrigue BELZILE, Leduc (CA)

(21) Appl. No.: 12/885,791

(22) Filed: Sep. 20, 2010

(30) Foreign Application Priority Data
Sep. 22, 2009 (CA) 2683140

(51) Int. Cl. B62D 9/00; B62D 7/06

(52) U.S. Cl. 180/252

(57) ABSTRACT

A vehicle including a symmetrical support frame having a width dimension and a length dimension, the width dimension and length dimension being substantially the same. At least three ground engaging wheels underlie and support the support frame. Each of the wheels are capable of 360 degree rotation. A driver station is mounted on the support frame for 360 degree rotation relative to the support frame. A steering control is provided with a steering linkage between the steering control, the driver station and the wheels, wherein rotational movement of the steering control by a selected number of degrees causes the driver station and each of the wheels to move a proportional number of degrees in the same rotational direction as the steering control with the driver station always facing a forward direction of the wheels.

### FIELD

The vehicle described has a driver station that can revolve 360 degrees.

### BACKGROUND

A motor vehicle has been developed by a Japanese firm which allows a driver compartment for the vehicle to be selectively turned on a vehicle frame to face in any desired direction. Wheels on the vehicle are independently controlled through an on-board computer. For example, when a driver turns the front wheels to the left to initiate a left turn, the computer turns the rear wheels to the right to reduce the turning radius. The driver can also override the computer to control wheel positioning. An example of where a combination of these features may be useful is when parking. A driver can rotate the driver compartment to face a parking space. The driver can then orient the wheels to drive the vehicle sideways into the parking space.

### SUMMARY

There is provided a vehicle including a symmetrical support frame having a width dimension and a length dimension, the width dimension and length dimension being substantially the same. At least three ground engaging wheels underlie and support the support frame. Each of the wheels is capable of 360 degree rotation. A driver station is mounted on the support frame for 360 degree rotation relative to the support frame. A steering control is provided with a steering linkage between the steering control, the driver station and the wheels, wherein rotational movement of the steering control by a selected number of degrees causes the driver station and each of the wheels to move a proportional number of degrees in the same rotational direction as the steering control with the driver station always facing a forward direction of the wheels.

With prior art vehicles, a driver turns a steering wheel in a selected rotational direction to effect a turn and then turns the wheel back to complete the turn. This is also true with the experimental Japanese vehicle described above. With the present vehicle, no particular portion of the vehicle must be facing forward during the vehicle's movement. This means that the driver need only turn the steering wheel to initiate a turn, the steering wheel need not be turned back. As the driver station is coordinated with the positioning of the wheels, the driver will always be facing the forward direction of the wheels. During the course of a journey, different portions of the support frame will take turns being the “front” of the vehicle. There is no need to “back up” a vehicle. By merely turning the steering wheel, the driver can drive forward into a parking stall, forward out of a parking stall, and into or out of any other conceivable location.

This teaching will change the way in which commuters drive their vehicles. It also has potential significance for vehicles used to transport heavy loads. Pneumatic tires are only capable of carrying a finite amount of weight. The more tires on a vehicle, the more weight that the vehicle is capable of carrying. By following the teachings described above, one can position wheels at spaced intervals under a support frame and the wheels will work together to carry heavy loads.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a vehicle.

FIG. 2 is a bottom plan view of the vehicle illustrated in FIG. 1.

FIG. 3 is a simplified top plan view of an intersection showing the vehicle of FIG. 1, going though positions a, b, and c when negotiating a turn.

FIG. 4 is a bottom plan view of a commercial vehicle.

FIG. 5 is a side elevation view of an alternative design of the vehicle illustrated in FIG. 1.

FIG. 6 is a bottom plan view of the vehicle illustrated in FIG. 5.

### DETAILED DESCRIPTION

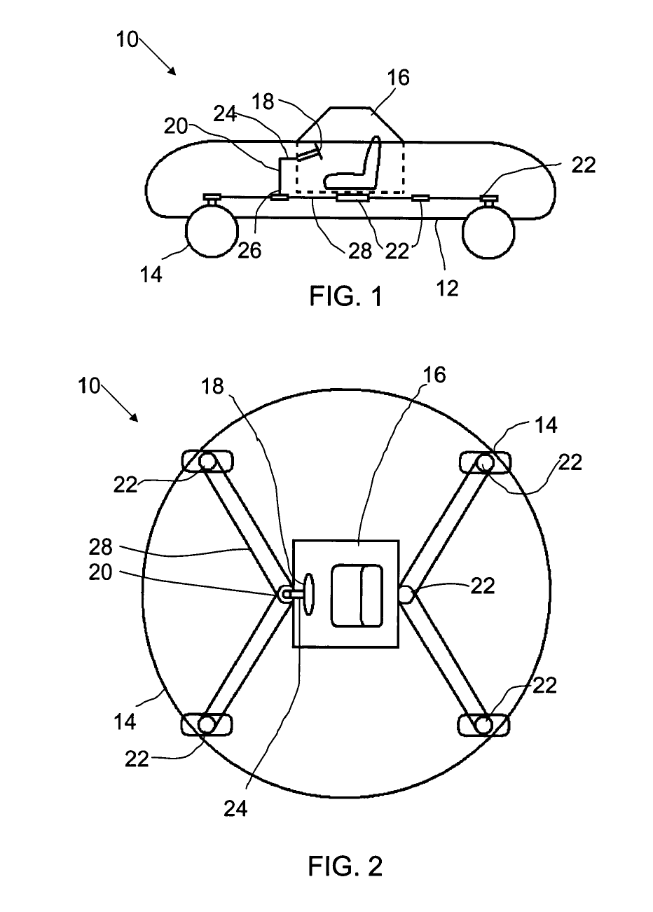

A vehicle with revolving driver station generally identified by reference numeral 10, will now be described with reference to FIG. 1 through FIG. 6.

### Structure and Relationship of Parts:

Referring to FIG. 1, a vehicle 10 includes a symmetrical support frame 12 which has a width dimension and a length dimension that are substantially the same, at least three ground engaging wheels 14 underlying the support frame 12 and supporting the support frame 12, a driver station 16 on the support frame 12 and a steering control 18. Each of the wheels 14 is capable of 360 degree rotation and the driver station 16 is mounted to allow for 360 degree rotation relative to the support frame 12.

A steering linkage 20 exists between the steering control 18, the driver station 16 and the wheels 14. The steering linkage 20 allows rotational movement of the steering control 18 by a selected number of degrees to cause the driver station 16 and each of the wheels 14 to move a proportional number of degrees in the same rotational direction as the steering control 18 with the driver station 16 always facing the forward direction of the wheels 14.

Referring to FIG. 2, gears 22 are attached to each of the wheels 14 and the steering control 18 rotates a steering column 24 that has a gear 22 at a remote end 26 of the steering column 24. A chain linkage 28 is provided between the gears 22, allowing rotation of the steering column 24 by a selected number of degrees to cause each of the wheels 14 to move a proportional number of degrees in the same rotational direction.

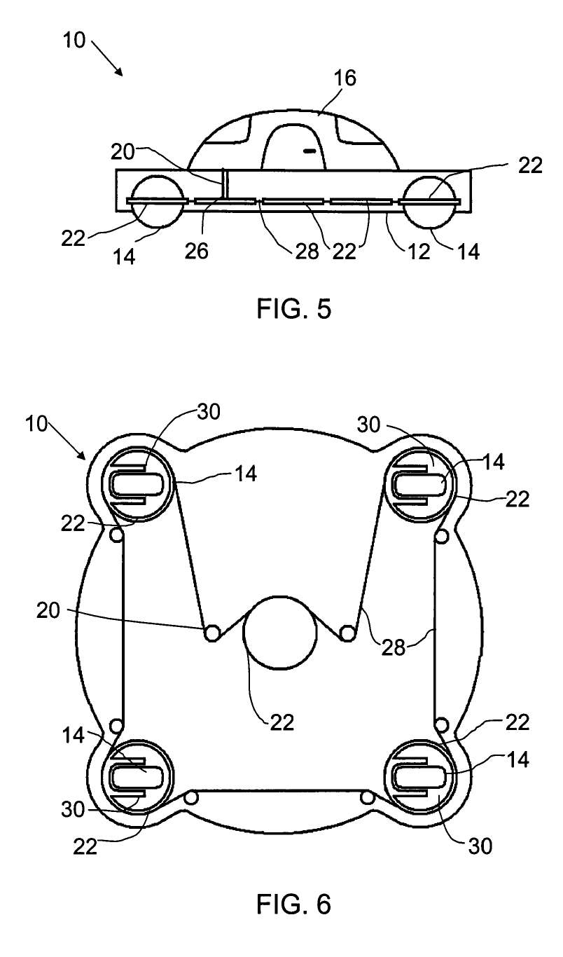

It will be understood that vehicle 10 may be implemented using various designs. For example, referring to FIGS. 5 and 6, gears 22 may be positioned around wheel 14, such that wheel 14 sits within the respective gear 22. This allows a lower profile to be obtained, and also permits driver's station 16 to extend over wheels 22, if desired. In this embodiment, referring to FIG. 6, wheel 14 may be mounted to gear 22 via forks 30, which may provide some suspension to vehicle 10. In addition, each wheel 14 is controlled by a single linkage 28 that is in contact with each gear 22. Steering linkage 20 is preferably powered to provide the necessary force to rotate the wheels and the driver's station, and may be powered by a separate motor from the motor that powers the drive train of vehicle 10.

### Operation:

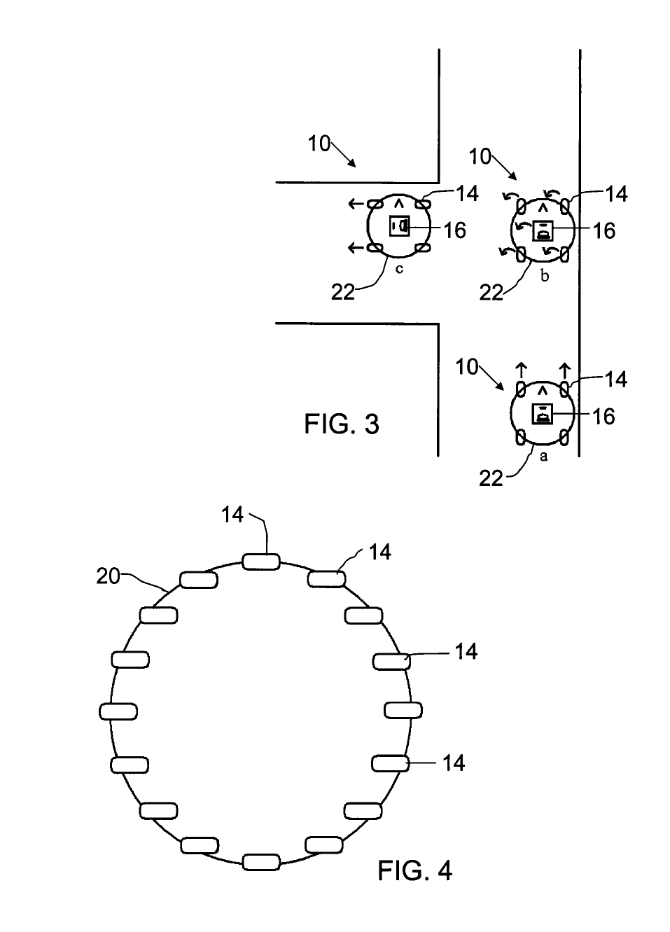

Referring to FIG. 3, a vehicle with revolving driver station 10 is moving straight at position “a”. The driver station 16 and wheels 14 face forwards. As the vehicle 10 begins to turn, driver station 16 and wheels 14 begin to rotate, as shown in position “b”.

Referring to FIGS. 1 and 2 as a steering control 18 is utilized to initiate a turn, the gears 22 and chain linkages 28 are caused to turn via the steering linkage 20. The steering linkage 20 allows a turn of the steering control 18 to result in rotational movement of the driver station 16 and the wheels 14 proportional to and in the same direction as the steering control 18.

Referring to FIG. 3, once the vehicle 10 has completed its turn, the driver station 16 and the wheels 14 are in a different orientation while the support frame 12 retains substantially the same orientation throughout the turn.

### Variations:

While a circular shape is shown, the body of vehicle 10 can be circular, triangular or any regular polygon (pentagon, hexagon, octagon). In the depicted embodiment, the support frame 12 is shown to be the same as the body of vehicle 10, which may not always be the case.

The steering linkage shown is rudimentary—there are other more sophisticated steering linkages that could be employed using cables, or hydraulic linkages.

The vehicle 10 may be equipped with any number of wheels 14 to allow for an increased load, as shown in FIG. 4, which shows an exaggerated number of wheels 14 connected to support frame 12.

In summary, some unique aspects regarding vehicle 10 and its manner of operation are as follows:
1 Wheels 14 are capable of turning 360 degrees.
2 Wheels 14 always turn (pivot) clockwise or counterclockwise together, so that they are always in the same relative position.
3 Driver station 16 (platform) turns (pivots) with the wheels clockwise or counterclockwise.
4 Support frame 12 that supports wheels 14 and driver station 16 (platform) does not change direction, even when vehicle 10 is travelling in circles.
5 When vehicle 10 is travelling in circles, each wheel 14 makes the same size circles, does the same number of rotations and travels the same distance.
6 When vehicle 10 is turning a corner, steering control 18 (steering wheel) is turned, but as soon as one stops turning steering control 18 (steering wheel), vehicle 10 goes straight again. This simplifies steering. On turns there is no need to turn back steering control 18 (steering wheel) at the end of the turn.
7 The preferred configuration for wheels 14 has a vertical pivot axis for steering that crosses a horizontal wheel axis support with forks support the wheels. This construction provides superior balance and strength. The wheel assembly becomes like a pillar.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A vehicle, comprising:
a symmetrical support frame having a width dimension and a length dimension, the width dimension and length dimension being substantially the same;
at least three ground engaging wheels underlying the support frame and supporting the support frame, each of the wheels being capable of 360 degree rotation;
a driver station on the support frame, mounted for 360 degree rotation relative to the support frame;
a steering control;
a steering linkage between the steering control, the driver station and the wheels, wherein rotational movement of the steering control by a selected number of degrees causes the driver station and each of the wheels to move a proportional number of degrees in the same rotational direction as the steering control with the driver station always facing a forward direction of the wheels.

2. The vehicle of claim 1, wherein gears are attached to each of the wheels, and the steering control rotates a steering column having a gear at a remote end of the steering column, a chain linkage being provided between the gears, wherein rotation of the steering column by a selected number of degrees causes each of the wheels to move a proportional number of degrees in the same rotational direction.
